(19) United States
(12) Patent Application Publication
(10) Pub. No.: US 2001/0053182 A1
(43) Pub. Date: Dec. 20, 2001

(54) Picture encoding format converting apparatus

(75) Inventor: Kiyoshi Ishiyama, Tokyo (JP)

Correspondence Address: Paul-J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/883,414

(22) Filed: Jun. 18, 2001

(30) Foreign Application Priority Data
Jun. 16, 2000 (JP) 2000-181852

(51) Int. Cl. H04N 7/12

(52) U.S. Cl. 375/240.05; 375/240.25; 375/240.26

(57) ABSTRACT

Disclosed is a picture encoding format converting apparatus, comprising: a picture decoder for decoding a picture signal from an input bitstream; a picture encoder for encoding the picture signal into an output bitstream; a main controller for controlling the amount of calculations executed by the picture encoder, on the basis of a state of the picture decoder.

### BACKGROUND OF THE INVENTION

1. Field of the Invention

The present invention relates to a picture encoding format converting apparatus, and in particular, to a picture encoding format converting apparatus featuring a controller for controlling the whole of the apparatus by controlling the operations of an decoder and a encoder for converting a picture encoding format.

2. Description of the Prior Art

Conventionally, when picture information is transmitted and stored in a digital picture communicating system and a digital picture communicating service, the picture information is encoded so as to decrease the number of bits.

As examples of the encoding formats for moving pictures that have been internationally standardized by ITU-T (International Telecommunication Union-Telecommunication Standardization Sector), H. 261 Recommendation (for transmission of pictures in television telephone and television conferences) and H. 263 Recommendation (for pictures transmitted over a low bit rate line such as PHS (Personal Handy-phone System)) are known.

In addition, as examples of the encoding formats for moving pictures that have been internationally standardized by ISO (International Organization for Standardization), MPEG (Motion Picture Experts Group) 1—an encoding format for stored video pictures, MPEG 2—a general-purpose encoding format, and MPEG 4—a low-bit encoding format are known.

Those encoding formats for compressing moving pictures are similar in that DCT (Discrete Cosine Transform), motion compensation prediction, and Huffman encoding are performed, but different in bitstreams that are actually encoded.

Thus, when bitstreams that are encoded in conformity with different standards are connected each other, it is necessary to decode a picture signal from an encoded picture signal and then encode the decoded picture signal to another encoded picture signal.

For example, in order to convert a bitstream in conformity with the H. 261 format to a bitstream in conformity with the H. 263 format or the MPEG 4 format, it is necessary to decode a picture signal from the former bitstream, and then, to encode the picture signal into the latter bitstream, because the latter bitstream is generated by an encoder not including a loop filter which is included in an encoder for generating the former bitstream.

In addition, in order to convert a bitstream in conformity with the H. 263 format or the MPEG 4 format to a bitstream in conformity with the H. 261 format, it is necessary to decode a picture signal from the former bitstream, and then, to encode the picture signal into the latter bitstream, because the maximum range of motion vectors of the H. 263 format and the MPEG 4 format is wider than that of motion vectors of the H. 261 format, and because a motion vector of the H. 261 format has an accuracy of integers at the best.

In other words, in order to convert a bitstream in conformity with a first picture encoding format to a bitstream in conformity with a second picture encoding format which is very different from the first picture encoding format, it is necessary to connect a decoder in conformity with the first picture encoding format and an encoder in conformity with the second picture encoding format, and it is necessary that the decoder decodes a picture signal from the former bitstream and the encoder encodes the picture signal into the latter bitstream.

FIG. 1 shows the structure of a conventional picture encoding format converting apparatus.

The picture encoding format converting apparatus shown in FIG. 1 comprises buffer 4, decoder 5, encoder 6, and buffer 7. The buffer 4 stores a bitstream that is output from an external device. The decoder 5 decodes a picture signal from a picture code which is output from the buffer 4. The encoder 6 encodes the picture signal which is output from the decoder 5 into a picture code. The buffer 7 stores the picture code which is output from the encoder 6 and outputs the picture code to an external device. The encoder 6 supervises the occupancy rate of the buffer 7. The occupancy rate of the buffer 7 is used for controlling the amount of the generated codes in the encoding process executed by the encoder 6.

A related art reference of the picture encoding format converting apparatus is disclosed in JPA 7-107461.

In the picture encoding format converting apparatus disclosed in the above-mentioned related art reference, history information of encoding parameters such as a motion vector and a quantizing step size used in the decoding process is stored. With reference to the encoding parameters in the encoding process, a re-encoding process is performed.

In JPA 7-288804, there is a disclosure that the number of quantizing bits is designated along with encoding parameters, such as a prediction mode, a motion vector, and a quantizing step size, which are obtained in the decoding process, so that a bitstream can be re-encoded into data of any amount.

In JPA 8-111870, there is a disclosure that re-eocoding a bitstream is performed using a period and phase of prediction modes, motion vectors, quantizing step sizes which are obtained in a decoding process of the bitstream.

In JPA 10-336672, there is a disclosure that motion vectors which are obtained when decoding is performed are stored, and encoding is performed using motion vectors which are based on the stored motion vectors, rescaled in accordance with a conversion ratio of picture size, and compensated in accordance with a conversion ration of frame rate.

In each of the conventional picture encoding format converting apparatuses, a process for decoding a picture signal from a received bitstream and a process for encoding the picture signal into another bitstream are simply repeated.

Thus, in each of the conventional picture encoding format converting apparatuses, even if the performance of the converting apparatus is improved, the surplus performance is not assigned to a process of improving picture quality or reducing the delay of the processes, because the decoding process and the encoding process are performed with fixed process amounts.

The conventional picture encoding format converting apparatuses have the following disadvantages.

A first disadvantage of the conventional picture encoding format converting apparatuses is that decoding of a picture signal from an input bitstream and encoding the picture signal into an output bitstream are simply repeated so as to convert the format of the input bitstream to the format of the output bitstream. Therefore, even if the performance of the converting apparatus is improved, the surplus performance is not allocated to a process of improving picture quality or reducing the delay of the processes.

In other words, even if the performance in a unit time is superfluous, the surplus performance is not allocated to a process of improving picture quality or reducing the delay of the processes.

A second disadvantage of conventional picture encoding format converting apparatuses as disclosed in JPA 7-107461, JPA 7-288804, JPA 8-111870, and JPA 10-336672 is that cooperative operation between the decoder and the encoder is not considered, though data exchange between the decoder and the encoder is considered in order to improve encoding efficiency or picture quality by reuseing encoding parameters which are obtained in decoding process, such as motion vectors, prediction modes, quantization step sizes.

When such a picture encoding format converting apparatus is accomplished by a DSP (Digital Signal Processor) or software of a personal computer, it is important to adequately share a process time among the decoder and the encoder in consideration of the situation.

In other words, when a picture encoding format conversion is performed in a particular unit time, the process times assigned to the decoder and the encoder should be varied in consideration of the feature of a bitstream so as to more flexibly convert the bitstream.

A third disadvantage of the conventional picture encoding format converting apparatuses is that the occupancy rate and fluctuation of an input buffer for storing a bitstream which is input from an external device are not considered.

If a bitstream of which encoding format is to be converted is supplied from a packet exchange network such as the Internet or ATM (Asynchronous Transfer Mode), the time when the bitstream is supplied from the packet exchange network to the input buffer tends to delay and fluctuate, because the transmission time varies depending on the congestion degree of the used line.

On the other hand, if the network is a fixed line network such as ISDN (Integrated Service Digital Network) or a telephone line, because a picture code is multiplexed with an audio code, a control signal, and so forth and the multiplexed bitstream is transmitted, when the picture code is extracted from the multiplexed bitstream and stored to an input buffer, the picture code tends to delay and fluctuate.

When the picture code delays and fluctuates, the occupancy rate of the input buffer varies.

If the occupancy rate of the input buffer is small, then the data amount of a bitstream waiting for conversion is small. Therefore, the decoder and the encoder should wait until a sufficient amount of a bitstream is stored in the input buffer.

In contrast, if the occupancy rate of the input buffer is large, then the bitstream is queued in the buffer for a long time. Therefore, the delay time in the picture encoding format converting apparatus becomes long.

Because the fluctuation of the occupancy rate of the input buffer elongates the delay time of a bitstream in the picture encoding format converting apparatus, and such fluctuation causes ineffective conversion of the bitstream, the occupancy rate of the input buffer should be controlled.

### SUMMARY OF THE INVENTION

In order to overcome the aforementioned disadvantages, the present invention has been made and accordingly, has an object to provide a picture encoding format converting apparatus which controls the entire process amount and the assignment of the processes of a decoder and an encoder so as to effectively use the performance to improve picture quality and shorten the delay of the processes and, to flexibly perform an encoding format conversion.

According to a first aspect of the present invention, there is provided a picture encoding format converting apparatus, comprising: a picture decoder for decoding a picture signal from an input bitstream; a picture encoder for encoding the picture signal into an output bitstream; a main controller for controlling the amount of calculations executed by the picture encoder, on the basis of a state of the picture decoder.

In the picture encoding format converting apparatus as set forth in claim 1, the picture decoder may comprise a buffer for temporarily storing the input bitstream, the picture encoder may comprise a rate controller for controlling a rate of the output bitstream, and the main controller may comprise: a monitor for monitoring an occupancy rate of the buffer; and a sub-controller for controlling the amount of calculations executed by the rate controller, on the basis of the occupancy rate in order to suppress fluctuation of the occupancy rate.

In the picture encoding format converting apparatus, the picture decoder may comprise a buffer for temporarily storing the input bitstream, the picture encoder may comprise a motion predictor for predicting motions in a picture represented by the picture signal, and the main controller may comprise: a monitor for monitoring an occupancy rate of the buffer; and a sub-controller for controlling the amount of calculations executed by the motion predictor, on the basis of the occupancy rate in order to suppress fluctuation of the occupancy rate.

In the picture encoding format converting apparatus, the picture decoder may comprise a buffer for temporarily storing the input bitstream, the picture encoder may comprise: a rate controller for controlling a rate of the output bitstream; and a motion predictor for predicting motions in a picture represented by the picture signal, and the main controller may comprise: a monitor for monitoring an occupancy rate of the buffer; and a sub-controller for controlling the amount of calculations executed by the rate controller and/or the amount of calculations executed by the motion predictor, on the basis of the occupancy rate in order to suppress fluctuation of the occupancy rate.

In the picture encoding format converting apparatus, the picture decoder may comprise a variable length decoder for decoding data of the picture signal from codes in the input bitstream, the picture encoder may comprise a rate controller for controlling a rate of the output bitstream, and the main controller may comprise: a monitor for monitoring encoding parameters decoded by the variable length decoder and for calculating the amount of calculations needed by the picture decoder; and a sub-controller for controlling the amount of calculations executed by the rate controller, on the basis of the amount of calculations needed by the picture decoder in order to keep the sum of the amount of calculations executed by the picture decoder and the amount of calculations executed by the picture encoder constant.

In the picture encoding format converting apparatus, the picture decoder may comprise a variable length decoder for decoding data of the picture signal from codes in the input bitstream, the picture encoder may comprise a motion predictor for predicting motions in a picture represented by the picture signal, and the main controller may comprise: a monitor for monitoring encoding parameters decoded by the variable length decoder and for calculating the amount of calculations needed by the picture decoder; and a sub-controller for controlling the amount of calculations executed by the motion predictor, on the basis of the amount of calculations needed by the picture decoder in order to keep the sum of the amount of calculations executed by the picture decoder and the amount of calculations executed by the picture encoder constant.

In the picture encoding format converting apparatus, the picture decoder may comprise a variable length decoder for decoding data of the picture signal from codes in the input bitstream, the picture encoder may comprise: a rate controller for controlling a rate of the output bitstream; and a motion predictor for predicting motions in a picture represented by the picture signal, and the main controller may comprise: a monitor for monitoring encoding parameters decoded by the variable length decoder and for calculating the amount of calculations needed by the picture decoder; and a sub-controller for controlling the amount of calculations executed by the rate controller and/or the amount of calculations executed by the motion predictor, on the basis of the amount of calculations needed by the picture decoder in order to keep the sum of the amount of calculations executed by the picture decoder and the amount of calculations executed by the picture encoder constant.

In the picture encoding format converting apparatus, the picture decoder may comprises: a buffer for temporarily storing the input bitstream; and a variable length decoder for decoding data of the picture signal from codes in the input bitstream, the picture encoder may comprise a rate controller for controlling a rate of the output bitstream, and the main controller may comprise: a monitor for monitoring an occupancy rate of the buffer, for monitoring encoding parameters decoded by the variable length decoder, and for calculating the amount of calculations needed by the picture decoder; and a sub-controller for controlling the amount of calculations executed by the rate controller, on the basis of the occupancy rate and/or the amount of calculations needed by the picture decoder in order to suppress fluctuation of the occupancy rate and/or keep the sum of the amount of calculations executed by the picture decoder and the amount of calculations executed by the picture encoder constant.

In the picture encoding format converting apparatus, the picture decoder may comprise: a buffer for temporarily storing the input bitstream; and a variable length decoder for decoding data of the picture signal from codes in the input bitstream, the picture encoder may comprise a motion predictor for predicting motions in a picture represented by the picture signal, and the main controller may comprise: a monitor for monitoring an occupancy rate of the buffer, for monitoring encoding parameters decoded by the variable length decoder, and for calculating the amount of calculations needed by the picture decoder; and a sub-controller for controlling the amount of calculations executed by the motion predictor, on the basis of the occupancy rate and/or the amount of calculations needed by the picture decoder in order to suppress fluctuations of the occupancy rate and/or keep the sum of the amount of calculations executed by the picture decoder and the amount of calculations executed by the picture encoder constant.

In the picture encoding format converting apparatus, the picture decoder may comprise: a buffer for temporarily storing the input bitstream; and a variable length decoder for decoding data of the picture signal from codes in the input bitstream, the picture encoder may comprise: a rate controller for controlling a rate of the output bitstream; and a motion predictor for predicting motions in a picture represented by the picture signal, and the main controller may comprise: a monitor for monitoring an occupancy rate of the buffer, for monitoring encoding parameters decoded by the variable length decoder, and for calculating the amount of calculations needed by the picture decoder; and a sub-controller for controlling the amount of calculations executed by the rate controller and/or the amount of calculations executed by the motion predictor, on the basis of the occupancy rate and/or the amount of calculations needed by the picture decoder in order to suppress fluctuations of the occupancy rate and/or the sum of the amount of calculations executed by the picture decoder and the amount of calculations executed by the picture encoder constant.

According to a second aspect of the present invention, there is provided an encoding format converting apparatus, comprising: a buffer for inputting encoded data and temporarily storing the encoded data; a decoder for decoding the data which has been temporarily stored in the buffer; an encoder for re-encoding the data which has been decoded by the decoder; and a controller for controlling the amount of calculations executed by the encoder in order to keep an occupancy rate of the buffer.

According to a third aspect of the present invention, there is provided an encoding format converting apparatus, comprising: a decoder for decoding data; an encoder for re-encoding the data which has been decoded by the decoder; and a controller for controlling the amount of calculations executed by the encoder in order to keep the sum of the amount of calculations executed by the decoder and the amount of calculations executed by the encoder constant, on the basis of the amount of calculations needed by the encoder.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the structure of a conventional picture encoding format converting apparatus;

FIG. 2 is a block diagram showing the structure of a picture encoding format converting apparatus according to a first embodiment of the present invention;

FIG. 3 is a block diagram showing the structure of a picture encoding format converting apparatus according to a second embodiment of the present invention;

FIG. 4 is a block diagram showing the structure of a picture encoding format converting apparatus according to a third embodiment of the present invention;

FIG. 5 is a block diagram showing the structure of a picture encoding format converting apparatus according to a fourth embodiment of the present invention;

FIG. 6 is a block diagram showing the structure of a picture encoding format converting apparatus according to a fifth embodiment of the present invention;

FIG. 7 is a block diagram showing the structure of a picture encoding format converting apparatus according to a sixth embodiment of the present invention;

FIG. 8 is a block diagram showing the structure of a picture encoding format converting apparatus according to a seventh embodiment of the present invention;

FIG. 9 is a block diagram showing the structure of a picture encoding format converting apparatus according to an eighth embodiment of the present invention;

FIG. 10 is a block diagram showing the structure of a picture encoding format converting apparatus according to a ninth embodiment of the present invention; and

FIG. 11 is a block diagram showing the structure of a picture encoding format converting apparatus according to a tenth embodiment of the present invention.

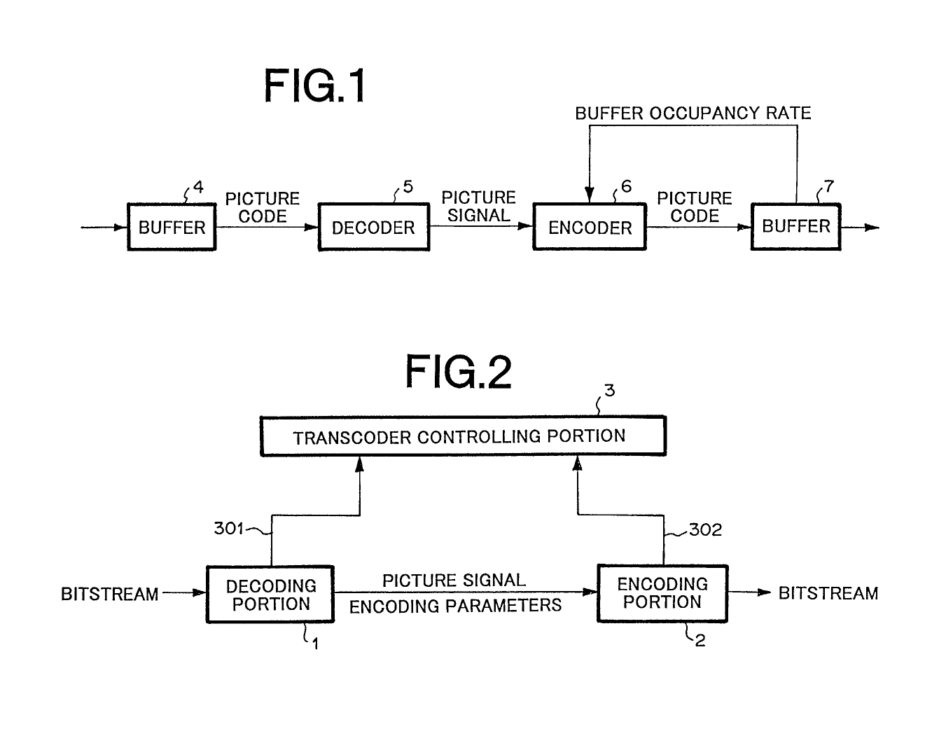

### DESCRIPTION OF PREFERRED EMBODIMENTS

Next, with reference to the accompanying drawings, embodiments of the present invention will be explained.

(First Embodiment)

Next, with reference to FIG. 2, the first embodiment of the present invention will be explained.

Referring to FIG. 2, the first embodiment of the present invention comprises decoding portion 1, encoding portion 2, and transcoder controlling portion 3.

With reference to FIG. 2, the operation of a picture encoding format converting apparatus according to the first embodiment of the present invention will be explained.

The decoding portion 1 decodes a picture signal from an encoded bitstream and sends the picture signal and encoding parameters to the encoding portion 2.

The encoding parameters are, for example, a prediction mode, a motion vector, and a quantizing step size.

The encoding portion 2 performs a re-encoding process using the picture signal and encoding parameters which are supplied from the decoding portion 1 and outputs a resultant bitstream.

In this case, the encoding portion 2 performs the re-encoding process corresponding to encoder operation information 302 which is supplied from the transcoder controlling portion 3.

The transcoder controlling portion 3 outputs the encoder operation information 302 to the encoding portion 2 corresponding to decoder state information 301 which is supplied from the decoding portion 1.

(Second Embodiment)

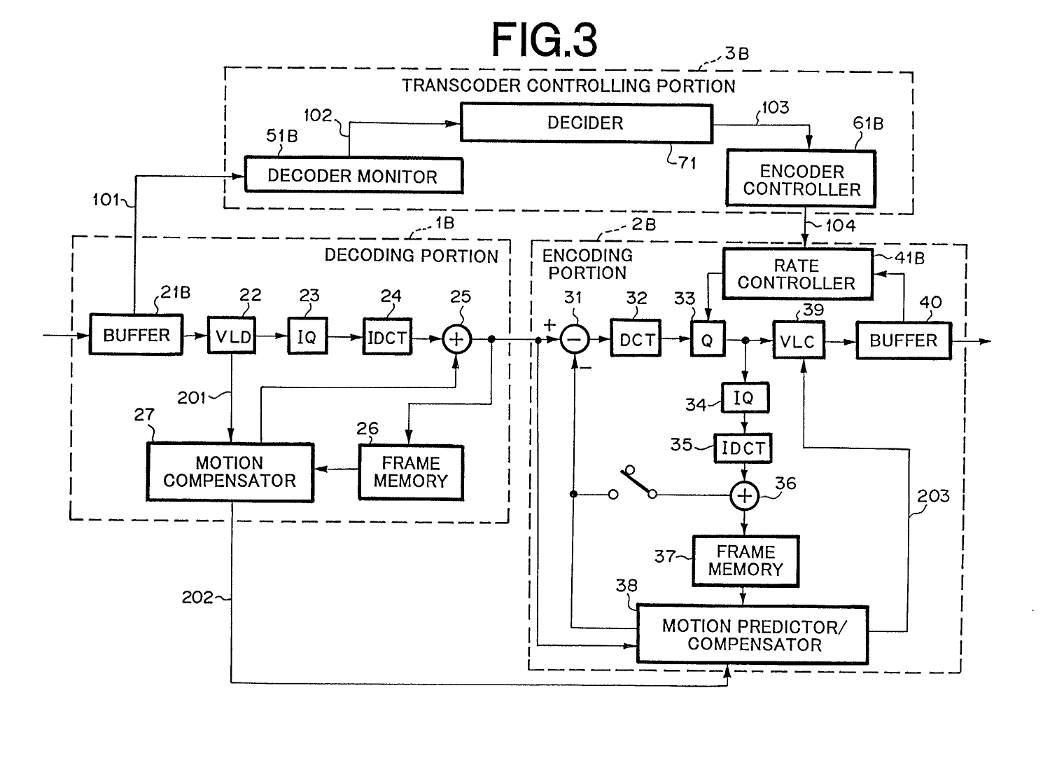

Next, with reference to FIG. 3, the second embodiment of the present invention will be explained in detail.

Referring to FIG. 3, the second embodiment of the present invention comprises decoding portion 1B, encoding portion 2B, and transcoder controlling portion 3B. The decoding portion 1B comprises a buffer 21B. The encoding portion 2B comprises a rate controller 41B. The transcoder controlling portion 3B comprises decoder monitor 51B, encoder controller 61B, and decider 71.

The decoding portion 1B further comprises VLD (Variable Length Decoder) 22, IQ (Inverse Quantizer) 23, IDCT (Inversely Discrete Cosine Transformer) 24, adder 25, frame memory 26, and motion compensator 27. The encoding portion 2B further comprises subtractor 31, a DCT (Discrete Cosine Transformer) 32, Q (Quantizer) 33, IQ 34, IDCT 35, adder 36, frame memory 37, a motion predictor/compensator 38, VLC (Variable Length Coder) 39, and buffer 40.

Next, with reference to FIG. 3, the operation of the picture encoding format converting apparatus according to the second embodiment of the present invention will be explained.

First of all, the operation of the decoding portion 1B will be explained.

The buffer 21B stores a bitstream that is supplied from an external device and outputs the stored bitstream to the VLD 22.

The VLD 22 performs an entropy decoding process such as a variable length decoding process or a run length decoding process for the bitstream which is supplied from the buffer 21B and outputs the decoded data as quantized DCT coefficients to the IQ 23.

The VLD portion 22 also outputs encoding parameters 201 such as a motion vector and a prediction mode to the motion compensator 27.

The IQ 23 inversely quantizes the quantized DCT coefficients which are supplied from the VLD 22 and outputs the non-quantized DCT coefficients to the IDCT 24.

The IDCT 24 performs an inversely discrete cosine transform matrix calculation for the DCT coefficients which are supplied from the IQ 23 and outputs the differential picture signal to the adder 25.

The adder 25 adds the differential picture signal which is supplied from the IDCT 24 and the picture signal which is supplied from the motion compensator 27, which will be explained later, and outputs the resultant signal to the frame memory 26 and to the subtractor 31 of the encoding portion 2B.

The frame memory portion 26 stores the picture signal which is supplied from the adder 25 for about a frame period.

The motion compensator 27 performs a motion compensation process for the picture signal stored in the frame memory portion 26 on the basis of the encoding parameters 201 which are supplied from the VLD 22 and outputs the resultant picture signal to the adder 25.

In addition, the motion compensator 27 outputs encoding parameters 202 to the motion predictor/compensator 38 of the encoding portion 2B.

Next, the operation of the encoding portion 2B will be explained.

When the picture signal that is supplied from the adder 25 is a P (Predictive) picture or a B (Bidirectionally-predictive) picture, the subtractor 31 subtacts a predicted signal which is supplied from the motion predictor/compensator 38, which will be explained later, from the picture signal which is supplied from the adder 25 and outputs the resultant signal to the DCT 32. In contrast, when the picture signal which is supplied from the adder 25 is an I (Intra) picture, the subtractor 31 directly outputs the input picture signal to the DCT 32.

The DCT 32 performs a discrete cosine transform matrix calculation for the picture signal which is supplied from the subtractor 31 and outputs the resultant DCT coefficients to the Q 33.

The Q 33 performs a quantizing calculation for the DCT coefficients which are input from the DCT 32 and outputs the resultant quantized DCT coefficients to the VLC 39 and the IQ 34.

The quantization characteristics such as a quantization step of the Q 33 is controlled by the rate controller 41B.

The IQ 34 performs an inversely quantizing calculation for the quantized DCT coefficients which are supplied from the Q 33 and outputs the resultant DCT coefficients to the IDCT 35.

The IDCT 35 performs an inversely discrete cosine transform matrix calculation for the DCT coefficients which are supplied from the IQ 34. When the input picture signal is of a P picture or a B picture, the IDCT 35 outputs a prediction error signal to the adder 36. When the input picture signal is of an I picture, the IDCT portion 35 outputs an encoded picture signal to the adder 36.

When the picture signal that is output from the IDCT 35 is of a P picture or a B picture, the adder 36 adds the picture signal which is supplied from the IDCT 35 and the prediction error signal supplied from the motion predictor/compensator 38 and outputs the resultant signal to the frame memory 37. In contrast, when the picture signal which is supplied from the IDCT portion 35 is of an I picture, the adder 36 directly supplies the picture signal which is supplied from the IDCT 35 to the frame memory portion 37.

The frame memory 37 stores the picture signal which is supplied from the adding portion 36 for about a frame period.

The motion predictor/compensator 38 performs a motion prediction process for the picture signal supplied from adder 25 and a motion compensation process for the picture signal which is stored in the frame memory portion 37 on the basis of the encoding parameters 202 which are supplied from the motion compensator 27, generates a motion-compensated predicted picture signal, and outputs the motion-compensated predicted picture signal to the subtractor 31 and the adder 36.

In addition, the motion predictor/compensator 38 outputs encoding parameters 203 to the VLC 39.

The VLC 39 performs an entropy encoding process such as a variable length encoding process or a run length encoding process for the quantized DCT coefficients which are supplied from the Q portion 33 and the encoding parameters 203 which are supplied from the motion predictor/compensator 38 and outputs the resultant encoded signal to the buffer 40.

The buffer 40 temporally stores the encoded signal which is supplied from the VLC 39 and outputs the encoded signal as a bitstream to an external device.

The rate controller 41B monitors the occupancy rate of the buffer 40 and controls the quantizing characteristics of the Q 33 on the basis of to the occupancy rate.

In addition, the rate controller 41B changes the rate controlling method on the basis of rate controller controlling information 104 which is supplied from the encoder controller 61B, which will be explained later. When the rate controlling method is changed, the calculation process amount of the rate controller 41B varies.

Next, the operation of the transcoder controlling portion 3B will be explained.

The decoder monitor 51B monitors the occupancy rate of the buffer 21B of the decoding portion 1B and outputs decoder state information 102 to the decider 71 on the basis of the buffer occupancy rate information 101.

The decider 71 decides the calculation process amount of the rate controller 41B of the encoding portion 2B on the basis of the decoder state information 102 so as to suppress the fluctuation of the occupancy rate of the buffer 21B.

When the occupancy rate of the buffer 21B is greater than a reference value or a target value, the decider 71 outputs encoder controlling information 103 to the encoder controller 61B so that the encoder controller 61B causes the rate controller 41B to decrease the process amount.

When the process amount of the rate controller 41B of the encoding portion 2B is decreased, the occupancy rate of the buffer 21B is decreased, because the share of the calculation time of the decoding portion 1B is relatively increased in the entire calculation time of the apparatus, provided that the decoding portion 1B and the encoding portion 2B share a calculating device such as a DSP or a CPU on time division basis.

In contrast, when the occupancy rate of the buffer 21B is less than the reference value or the target value or when an underflow takes place because of the occupancy rate having approached zero, the decider 71 outputs encoder controlling information 103 to the encoder controller 61B so that the encoder controller 61B causes the rate controller 41B to increase the process amount.

When the process amount of the rate controller 41B of the encoding portion 2B is increased, the occupancy rate of the buffer 21B is increased, because the share of the calculation time of the decoding portion 1B is relatively decreased in the entire calculation time of the apparatus.

In addition, when the process amount of the rate controller 41B is increased, there is caused other effects that the picture quality is improved and the amount of generated codes decreases.

In order to vary the process amount of the rate controlling process, the method for the rate controlling process is changed.

Characteristics, such as complexity and effects, of typical rate controlling method vary. Thus, by switching from one method to another method, the process amount of the rate controlling process is varied.

The process amount of the rate controlling process is varied (1) when changing a method for using a history of the amount of generated codes, (2) when changing a method for using the distribution of the AC powers of DCT coefficients, (3) when changing a period of updating quaitization steps, (4) when changing the accuracy of calculations, and so forth.

When the encoder controlling information 103 is supplied from the decider 71 to the encoder controller 61B, the controller 61B outputs rate controller controlling information 104 to the rate controller 41B of the encoding portion 2B.

(Third Embodiment)

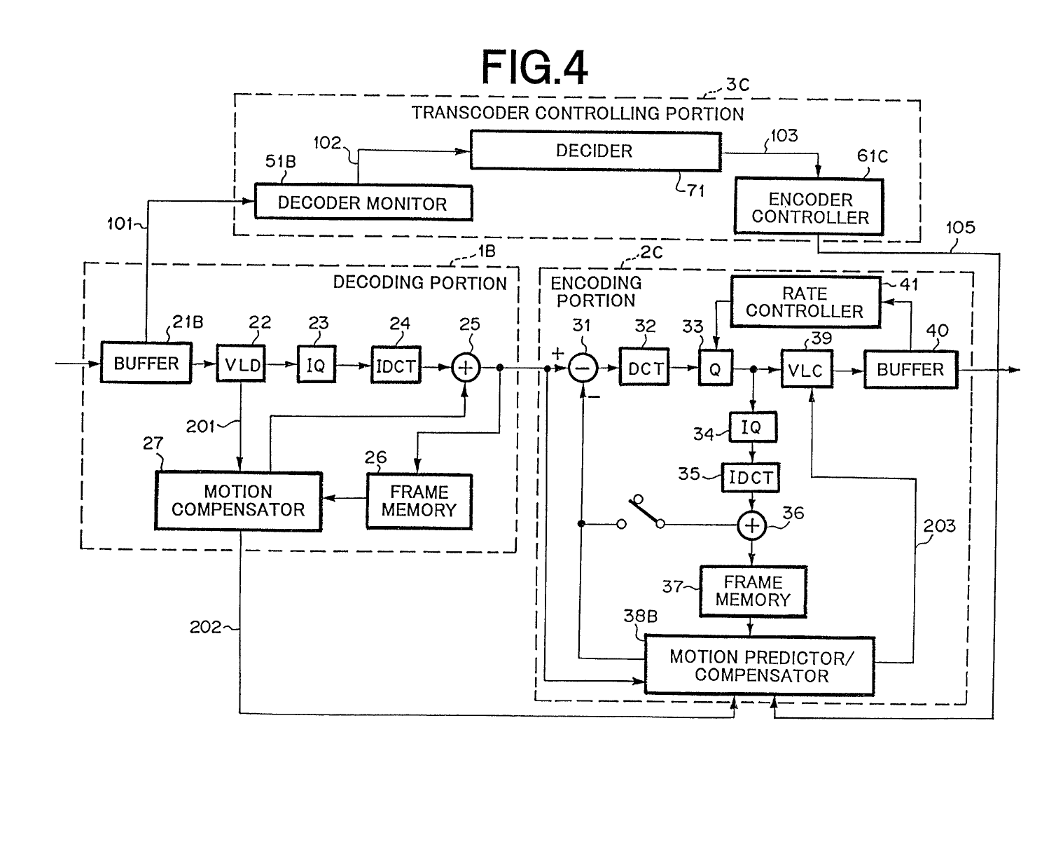

Next, with reference to FIG. 4, a third embodiment of the present invention will be explained.

Referring to FIG. 4, the third embodiment of the present invention comprises a decoding portion 1B, an encoding portion 2C, and a transcoder controlling portion 3C. The decoding portion 1B comprises buffer 21B. The encoding portion 2C comprises motion predictor/compensator 38B. The transcoder controlling portion 3C comprises decoder monitor 51B, encoder controller 61C, and decider 71.

The decoding portion 1B further comprises VLD (Variable Length Decoder) 22, IQ (Inversely Quantizer) 23, IDCT (Inversely Discrete Cosine Transformer) 24, adder 25, frame memory 26, and motion compensator 27. The encoding portion 2C further comprises subtractor 31, DCT (Discrete Cosine Transformer) 32, Q (Quantizer) 33, IQ 34, IDCT 35, adder 36, frame memory 37, VLC (Variable Length Coder) 39, buffer 40, and rate controller 41.

Next, with reference to FIG. 4, the operation of the picture encoding format converting apparatus according to the third embodiment will be explained.

The operation of the decoding portion 1B according to the third embodiment is the same as that according to the second embodiment.

Next, the operation of the encoding portion 2C will be explained.

The operations of the subtractor 31, the DCT 32, the Q 33, the IQ 34, the IDCT 35, the adder 36, the frame memory 37, the VLC 39, and the buffer 40 according to the third embodiment are the same as those according to the second embodiment.

The motion predictor/compensator 38B performs a motion prediction process for the picture signal supplied from adder 25 and a motion compensation process for a picture signal stored in the frame memory 37 on the basis of motion predictor/compensator controlling information 105 which is supplied from the encoder controller 61C, which will be explained later, and encoding parameters 202 which are supplied from the motion compensator 27, generates a motion-compensated picture signal, and outputs the resultant picture signal to the subtractor 31 and the adder 36.

The motion predictor/compensator 38B outputs the encoding parameters 203 to the VLC 39.

The rate controller 41 monitors the buffer 40 and controls the quantizing characteristics of the Q 33 on the basis of the monitored result.

Next, the operation of the transcoder controlling portion 3C will be explained.

The decoder monitor 51B monitors the occupancy rate of the buffer 21B of the decoding portion 1B and outputs decoder state information 102 to the decider 71 on the basis of the occupancy rate information 101.

The decider 71 decides the operation of the motion predictor/compensator 38B of the encoding portion 2C on the basis of the decoder state information 102 so as to suppress the occupancy rate of the buffer 21B from fluctuating.

When the occupancy rate of the buffer 21B is greater than a reference value or a target value, the decider 71 outputs encoder controlling information 103 to the encoder controller 61C so that the encoder controller 61C causes the motion predictor/compensator 38B to decrease the process amount.

When the process amount of the motion predictor/compensator 38B of the encoding portion 2C is decreased, the occupancy rate of the buffer 21B is decreased, because the share of the calculation time of the decoding portion 1B is relatively increased in the calculation time of the entire apparatus, provided that the decoding portion 1B and the encoding portion 2B share a calculating device such as a DSP or a CPU on time division basis.

In contrast, when the occupancy rate of the buffer 21B is less than the reference value or the target value or when an underflow takes place because of the occupancy rate of the buffer having approached zero, the decider 71 outputs encoder controlling information 103 to the encoder controller 61B so that the encoder controller 61B causes the motion predictor/compensator 38B to increase the process amount.

When the process amount of the motion predictor/compensator 38B of the encoding portion 2C is increased, the occupancy rate of the buffer 21B is increased, because the share of the calculation time of the decoding portion 1B is relatively decreased in the calculation time of the entire apparatus.

In addition, when the process amount of the motion predictor/compensator 38B is increased, there is caused other effects that the picture quality is improved and the amount of generated codes decreases.

In order to vary the process amount of the motion predictor/compensator 38B, a search range in which a motion vector is predicted is changed.

When the picture encoding format is converted, a motion vector supplied from decoding portion 1B can be reused in encoding portion 2C.

The fluctuation of the picture quality in a case where the search range is varied while reusing a motion vector is less than that in a case where the search range is varied while not using the motion vector, provided that the same amount of codes is generated.

Therefore, when the search range is decreased, the deterioration of the picture quality in the case where a motion vector is reused is less than that in the case where the motion vector is not reused.

Another method for varying the process amount of the motion predictor/compensator 38B is based on an abortion of motion prediction as follows: A threshold value is designated against an evaluation function, such as an MAE (Mean Absolute Error) or an MSE (Mean Square Error), at a search point obtained during a motion prediction. The evaluation function value and the threshold value are compared. When the evaluation function value is greater than the threshold value, the motion prediction is aborted.

In this case, if a large threshold value is designated, the process amount of the motion prediction is decreased. In contrast, when a small threshold value is designated, the process amount for the motion prediction is increased.

The above-mentioned method for controlling the process amount of the motion prediction may be combined with another method for controlling the process amount of the motion prediction.

When encoder controlling information 103 is supplied from the decider 71 to the encoder controller 61C, the controller 61C outputs motion predictor/compensator controlling information 105 to the motion predictor/compensator 38B.

(Fourth Embodiment)

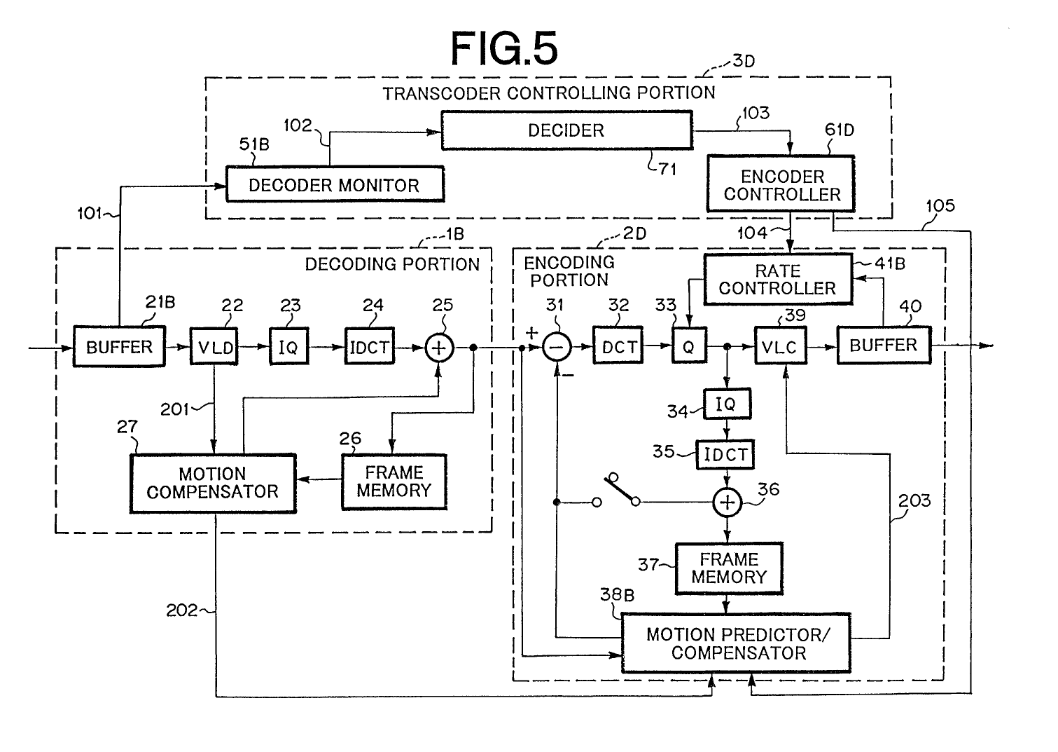

Next, with reference to FIG. 5, a fourth embodiment of the present invention will be explained.

Referring to FIG. 5, the fourth embodiment of the present invention comprises decoding portion 1B, encoding portion 2D, and transcoder controlling portion 3D. The decoding portion 1B comprises buffer 21B. The encoding portion 2D comprises motion predictor/compensator 38B and rate controller 41B. The transcoder controlling portion 3D comprises decoder monitor 51B, encoder controller 61D, and decider 71.

The decoding portion 1B further comprises VLD (Variable Length Decoder) 22, IQ (Inversely Quantizer) 23, IDCT (Inversely Discrete Cosine Transformer) 24, adder 25, frame memory 26, and motion compensator 27. The encoding portion 2D further comprises subtractor 31, DCT (Discrete Cosine Transformer) 32, Q (Quantizer) 33, IQ 34, IDCT 35, adder 36, frame memory 37, VLC (Variable Length Coder) 39, and buffer 40.

Next, with reference to FIG. 5, the operation of the picture encoding format converting apparatus according to the fourth embodiment will be explained.

The operation of the decoding portion 1B according to the fourth embodiment is the same as that according to the second embodiment.

Next, the operation of the encoding portion 2D according to the fourth embodiment will be explained.

The operations of subtractor 31, the DCT 32, the Q 33, the IQ 34, the IDCT 35, the adder 36, the frame memory 37, the VLC 39, and the buffer 40 according to the fourth embodiment are the same as those according to the second embodiment.

The motion predictor/compensator 38B performs a motion detecting process for the picture supplied from adder 25 and a motion compensation predicting process for the picture signal stored in the frame memory portion 37 on the basis of motion predictor/compensator controlling information 105 which is supplied from the encoder controller 61D, which will be explained later, and encoding parameters 202 which are supplied from the motion compensator 27, generates a motion compensation predicted picture signal, and outputs the generated picture signal to the subtractor 31 and the adder 36.

The motion predictor/compensator 38B outputs the encoding parameters 203 to the VLC 39.

The rate controller 41B monitors the buffer 40 and controls quantizing characteristics of the Q 33 on the basis of the state of the buffer 40 and rate controller controlling information 104 which is supplied from the encoder controller 61D, which will be explained later.

The rate controller 41B changes the rate controlling method on the basis of the rate controller controlling information 104 which is supplied from the encoder controller 61D, which will be explained later.

Next, the operation of the transcoder controlling portion 3D will be explained.

The decoder monitor 51B monitors the occupancy rate of the buffer 21B of the decoding portion 1B and outputs decoder state information 102 to the decider 71 on the basis of the buffer occupancy rate information 101.

The decider 71 decides the operations of the rate controller 41B and the motion predictor/compensator 38B of the encoding portion 2D on the basis of the decoder state information 102 so as to suppress the occupancy rate of the buffer 21B from fluctuating.

When the occupancy rate of the buffer 218 is greater than a predetermined reference value or target value, the decider 71 outputs encoder controlling information 103 to the encoder controller 61D so as to decrease the process amount for the encoding portion 2D.

Corresponding to the encoder controlling information 103, the decider 71 selects one of three methods, i.e. (1) a method for decreasing the process amount of only the rate controller 41B, (2) a method for decreasing the process amount of only the motion predictor/compensator 38B, and (3) a method for decreasing the process amounts for both the rate controller 41B and the motion predictor/compensator 38B.

When the process amount of the encoding portion 2D is decreased, the occupancy rate of the buffer 218 is decreased, because the share of the calculation time of the decoding portion 1 is relatively increased in calculation time of the entire apparatus, provide that the decoding portion 1B and the encoding portion 2D share a calculating device such as a DSP or a CPU on time division basis.

In contrast, when the occupancy rate of the buffer 218 is less than the predetermined reference value or the target value or when an underflow takes place because of the occupancy rate of the buffer having approached zero, the decider 71 outputs the encoder controlling information 103 to the encoder controller 61D so that the encoder controller 61D causes the encoding portion 2D to increase the process amount.

Corresponding to the encoder controlling information 103, the decider 71 can select one of three methods, i.e. (1) a method for increasing the process amount of only the rate controller 41B, (2) a method for increasing the process amount of only the motion predictor/compensator 38B, and (3) a method for increasing the process amounts for both the rate controller 41B and the motion predictor/compensator 38B.

When the process amount of the encoding portion 2D is increased, the occupancy rate of the buffer 21B is increased, because the share of the calculation time of the decoding portion 1B is relatively decreased in the calculation time of the entire apparatus.

When the encoder controlling information 103 is input from the decider 71 to the encoder controller 61D, the encoder controller 61D outputs rate controller controlling information 104 to the rate controller 41B of the encoding portion 2D and/or motion predictor/compensator controlling information 105 to the motion predictor/compensator 38B of the encoding portion 2D.

(Fifth Embodiment)

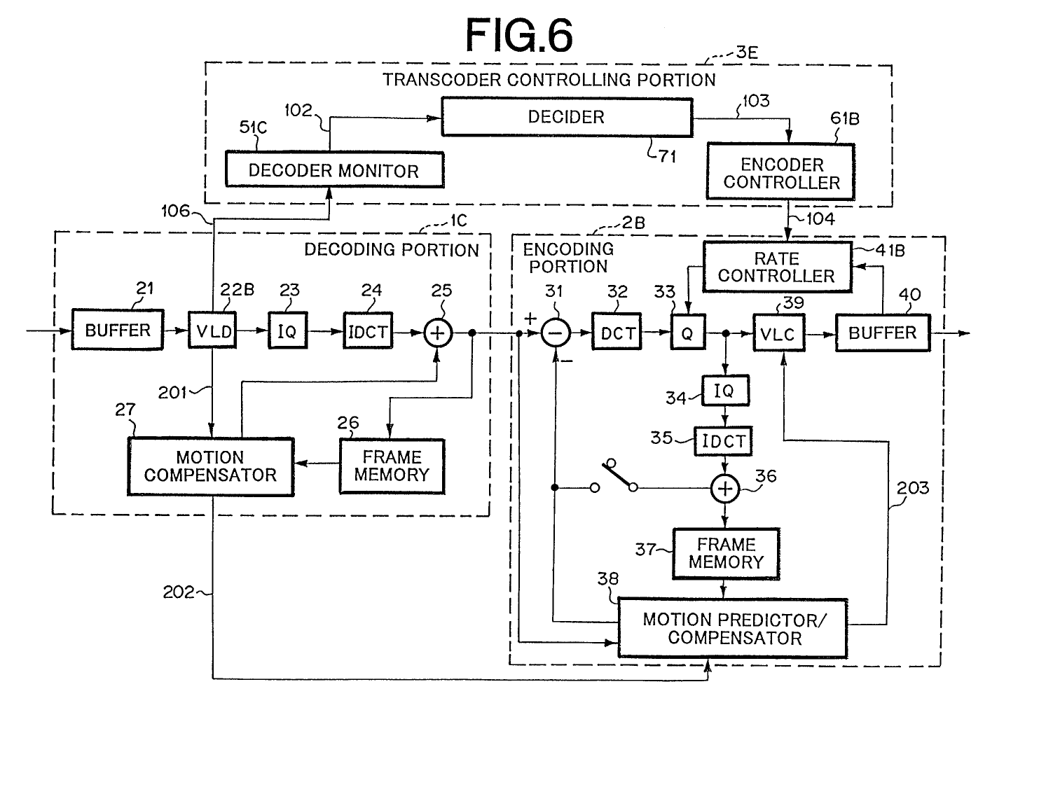

Next, with reference to FIG. 6, the fifth embodiment of the present invention will be explained.

Referring to FIG. 6, the fifth embodiment of the present invention comprises decoding portion 1C, encoding portion 2B, and transcoder controlling portion 3E. The decoding portion 1C comprises VLD (Variable Length Decoder) 22B. The encoding portion 2B comprises rate controller 41B. The transcoder controlling portion 3E comprises decoder monitor 51C, encoder controller 61B, and decider 71.

The decoding portion 1C further comprises buffer 21, IQ (Inversely Quantizer) 23, IDCT (Inversely Discrete Cosine Transformer) 24, adder 25, frame memory 26, and motion compensator 27. The encoding portion 2B further comprises subtractor 31, DCT (Discrete Cosine Transformer) 32, Q (Quantizer) 33, IQ 34, IDCT 35, adder 36, frame memory 37, motion predictor/compensator 38, VLC (Variable Length Coder) portion 39, and buffer 40.

Next, with reference to FIG. 6, the operation of the picture encoding format converting apparatus according to the fifth embodiment of the present invention will be explained.

First of all, the operation of the decoding portion 1C will be explained.

The operations of the IQ portion 23, the IDCT portion 24, the adder 25, the frame memory 26, and the motion compensator 27 according to the fifth embodiment are the same as those according to the second embodiment. The operation of the buffer 21 according to the fifth embodiment is the same as the operation of the buffer 21B except that the buffer 21 does not output the buffer occupancy rate information 101.

The VLD 22B performs an entropy decoding process such as a variable length decoding process or a run length decoding process for a bitstream which is supplied from the buffer 21 and outputs decoded quantized DCT coefficients to the IQ 23.

In addition, the VLD 22B decodes and outputs encoding parameters 201 such as a motion vector and a prediction mode to the motion compensator 27. Moreover, the VLD 22B outputs encoding parameters 106 to the decoder monitor 51C.

The operation of the encoding portion 2B according to the fifth embodiment is the same as the operation of the encoding portion 2B according to the second embodiment.

Next, the operation of the transcoder controlling portion 3E will be explained.

The decoder monitor 51C calculates how much process amount the decoding portion 1C requires to decode a predetermined unit picture on the basis of encoding parameters 106 and outputs the result as decoder state information 102 to the decider 71.

The process amount for the decoding portion 1C is calculated on the basis of the number of macro blocks for which a motion compensation process is performed, the number of macro blocks for which an IDCT process is performed, the number of macro blocks, each of which has difference data between the current frame and the immediately preceding frame, or the like.

On the basis of the decoder state information 102, the decider 71 outputs encoder controlling information 103 to the encoder controller 61B so that the encoding portion 2B is assigned with a residual performance which is obtained by subtracting the performance needed by the decoding portion 1C from the performance assigned to the decoding portion 1C and the encoding portion 2B in common.

In other words, the decider 71 controls the encoder controller 61B so that the process amount for the entire picture encoding format converting apparatus is kept constant in such a manner that when the process amount for the decoding portion 1C becomes large, the process amount for the encoding portion 2B is decreased and that when the process amount for the decoding portion 1C becomes small, the process amount for the encoding portion 2B is increased, provided that the decoding portion 1C and the encoding portion 2B share a calculating device such as a DSP or a CPU on time division basis.

Thus, since the calculation amount for decoding and encoding a predetermined number of macro blocks becomes constant, the delay time caused in the entire picture encoding format converting apparatus is kept constant.

When the encoder controlling information 103 is supplied from the decider 71 to the encoder controller 61B, encoder controller 61B outputs rate controller controlling information 104 to the rate controller 41B of the encoding portion 2B.

(Sixth Embodiment)

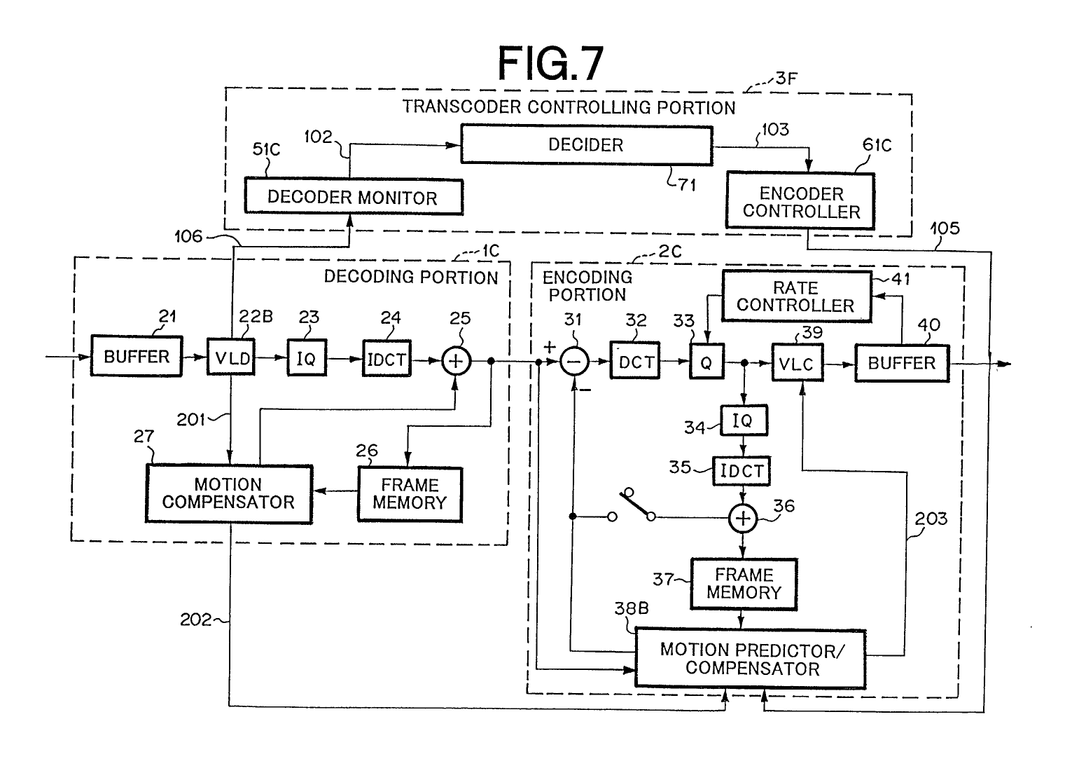

Next, with reference to FIG. 7, a sixth embodiment of the present invention will be explained.

Referring to FIG. 7, the sixth embodiment of the present invention comprises decoding portion 1C, encoding portion 2C, and transcoder controlling portion 3F. The decoding portion 1C comprises VLD (Variable Length Decoder) 22B. The encoding portion 2C comprises motion predictor/compensator 38B. The transcoder controlling portion 3F comprises decoder monitor 51C, encoder controller 61C, and decider 71.

The decoding portion 1C further comprises buffer 21, IQ (Inversely Quantizer) 23, IDCT (Inversely Discrete Cosine Transformer) 24, adder 25, frame memory 26, and motion compensator 27. The encoding portion 2C further comprises subtractor 31, DCT (Discrete Cosine Transformer) 32, Q (Quantizer) 33, IQ 34, IDCT 35, adder 36, frame memory 37, VLC (Variable Length Coder) 39, buffer 40, and rate controller 41.

Next, with reference to FIG. 7, the operation of the picture encoding format converting apparatus according to the sixth embodiment of the present invention will be explained.

The operation of the decoding portion 1C according to the sixth embodiment is the same as that according to the fifth embodiment.

The operation of the encoding portion 2C according to the sixth embodiment is the same as that according to the third embodiment.

Next, the operation of the transcoder controlling portion 3F will be explained.

The decoder monitor 51C calculates how much process amount the decoding portion 1C requires to decode a predetermined unit on the basis of encoding parameters 106 and outputs the result as decoder state information 102 to the decider 71.

The decider 71 outputs encoder controlling information 103 to the encoder controller 61C on the basis of decoder state information 102 so that the encoding portion 2C is assigned with a residual performance which is obtained by subtracting the performance needed by the decoding portion 1C from the performance assigned to the decoding portion 1C and the encoding portion 2C in common.

In other words, the decider 71 controls the encoder controller 61C so that the process amount for the entire picture encoding format converting apparatus is kept constant in such a manner that when the process amount for the decoding portion 1C becomes large, the process amount for the encoding portion 2C is decreased and that when the process amount for the decoding portion 1C becomes small, the process amount for the encoding portion 2C is increased, provided that the decoding portion 1C and the encoding portion 2C share a calculating device such as a DSP or a CPU on time division basis.

Thus, since the calculation amount for decoding and encoding a predetermined number of macro blocks becomes constant, the delay time caused in the entire picture encoding format converting apparatus is kept constant.

When the encoder controlling information 103 is supplied from the decider 71 to the encoder controller 61C, the encoder controller 61C outputs motion predictor/compensator controlling information 105 to the motion predictor/compensator 38B of the encoding portion 2C.

(Seventh Embodiment)

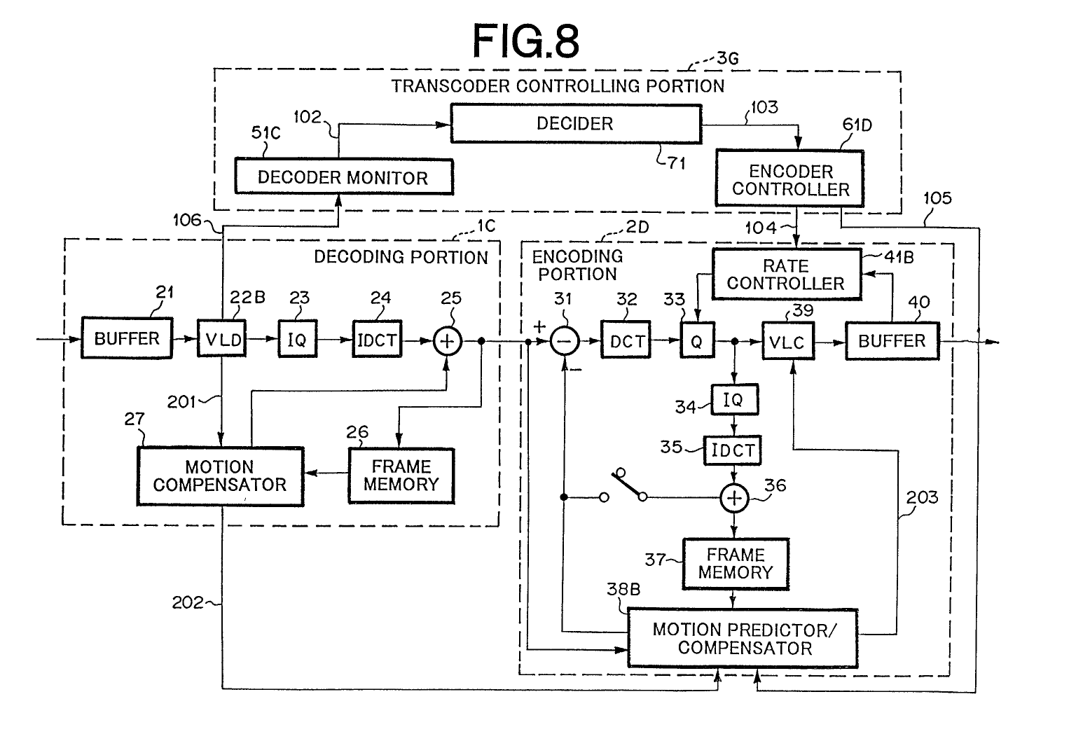

Next, with reference to FIG. 8, the seventh embodiment of the present invention will be explained.

Referring to FIG. 8, the seventh embodiment of the present invention comprises decoding portion 1C, encoding portion 2D, and transcoder controlling portion 3G. The decoding portion 1C comprises VLD (Variable Length Decoder) 22B. The encoding portion 2D comprises motion predictor/compensator 38B and rate controller 41B. The transcoder controlling portion 3G comprises decoder monitor 51C, encoder controller 61D, and decider 71.

The decoding portion 1C further comprises buffer 21, IQ (Inversely Quantizer) 23, IDCT (Inversely Discrete Cosine Transformer) 24, adder 25, frame memory 26, and motion compensator 27. The encoding portion 2D further comprises subtractor 31, DCT (Discrete Cosine Transformer) 32, Q (Quantizer) 33, IQ 34, IDCT 35, adder 36, frame memory 37, VLC (Variable Length Coder) 39, and buffer 40.

Next, with reference to FIG. 8, the operation of the picture encoding format converting apparatus according to the seventh embodiment of the present invention will be explained.

The operation of the decoding portion 1C according to the seventh embodiment is the same as that according to the fifth embodiment.

The operation of the encoding portion 2D according to the seventh embodiment is the same as that according to the fourth embodiment.

Next, the operation of the transcoder controlling portion 3G will be explained.

The decoder monitor 51C calculates how much process amount the decoding portion 1C requires to decode a predetermined unit picture on the basis of encoding parameters 106 and outputs the result as decoder state information 102 to the decider 71.

The decider 71 outputs encoder controlling information 103 to the encoder controller 61D on the basis of decoder state information 102 so that the encoding portion 2B is assigned with a residual performance which is obtained by subtracting the performance needed by the decoding portion 1C from the performance assigned to the decoding portion 1C and the encoding portion 2B in common, provided that the decoding portion 1C and the encoding portion 2D share a calculating device such as a DSP or a CPU on time division basis.

In other words, the decider 71 controls the encoder controller 61D so that the process amount for the entire picture encoding format converting apparatus is kept constant in such a manner that when the process amount for the decoding portion 1C becomes large, the process amount for the encoding portion 2D is decreased and that when the process amount for the decoding portion 1C becomes small, the process amount for the encoding portion 2D is increased.

Thus, since the calculation amount for decoding and encoding a predetermined number of macro blocks becomes constant, the delay time caused in the entire picture encoding format converting apparatus is kept constant.

Like the fourth embodiment, when the encoder controlling information 103 is supplied from the decider 71 to the encoder controller 61D, the encoder controller 61D outputs rate controller controlling information 104 and/or motion predictor/compensator controlling information 105 to the rate controller 41B and/or the motion predictor/compensator 38B of the encoding portion 2D.

(Eighth Embodiment)

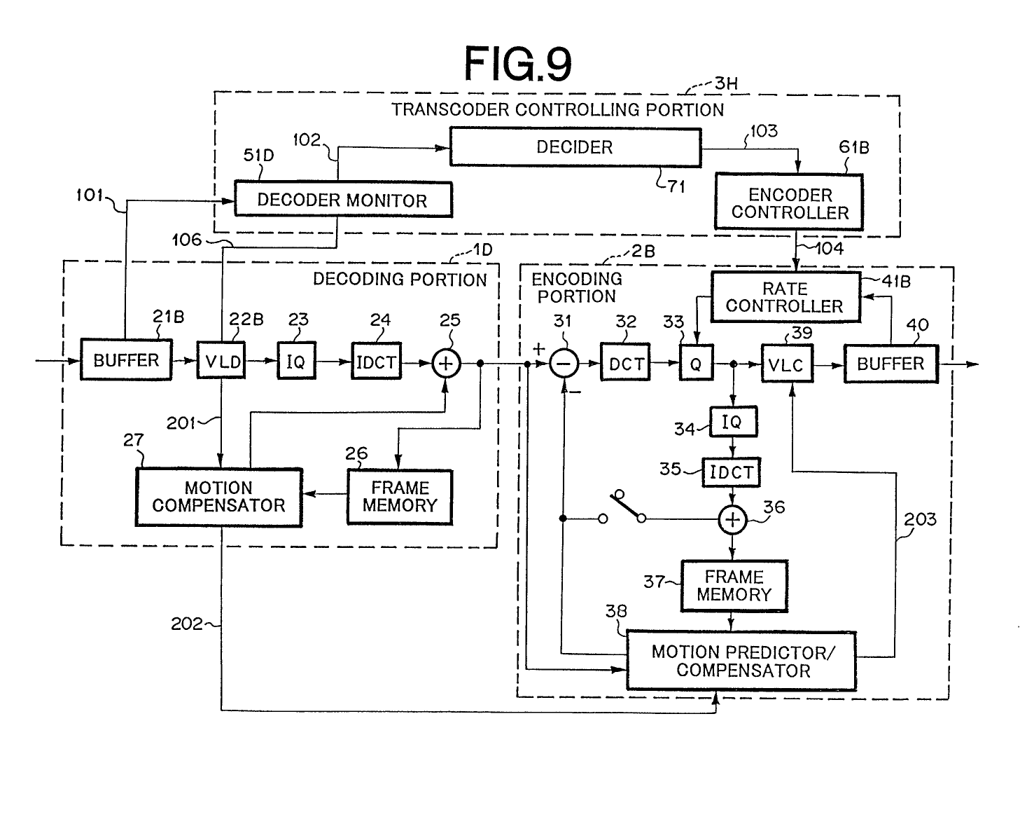

Next, with reference to FIG. 9, an eighth embodiment of the present invention will be explained.

Referring to FIG. 9, the eighth embodiment of the present invention comprises decoding portion 1D, encoding portion 2B, and transcoder controlling portion 3H. The decoding portion 1D comprises buffer 21B and VLD (Variable Length Decoder) 22B. The encoding portion 2B comprises rate controller 41B. The transcoder controlling portion 3H comprises decoder monitor 51D, encoder controller 61B, and decider 71.

The decoding portion 1D further comprises IQ (Inversely Quantizer) 23, IDCT (Inversely Discrete Cosine Transformer) 24, adder 25, frame memory 26, and motion compensator 27. The encoding portion 2B further comprises subtractor 31, DCT (Discrete Cosine Transformer) 32, Q (Quantizer) 33, IQ 34, IDCT 35, adder 36, frame memory 37, motion predictor/compensator 38, VLC (Variable Length Coder) 39, and buffer 40.

Next, with reference to FIG. 9, the operation of the picture encoding format converting apparatus according to the eighth embodiment of the present invention will be explained.

Next, the operation of the decoding portion 1D will be explained.

The operations of the buffer 21B, the IQ portion 23, the IDCT portion 24, the adder 25, the frame memory 26, and the motion compensator 27 according to the eighth embodiment are the same as those according to the second embodiment.

The operation of the VLD 22B according to the eighth embodiment is the same as that according to the fifth embodiment.

The operation of the encoding portion 2B according to the eighth embodiment is the same as that according to the second embodiment.

Next, the operation of the transcoder controlling portion 3H will be explained.

The decoder monitor 51D monitors the occupancy rate of the buffer 21 of the decoding portion 1D.

In addition, the decoder monitor 51D calculates how much process amount the decoding portion 1D requires to decode a predetermined unit picture on the basis of encoding parameters 106 which are supplied from the VLD 22B.

The decoder monitor 51D outputs decoder state information 102 to the decider 71 on the basis of both buffer occupancy rate information 101 and encoding parameters 106.

The decider 71 decides the operation of the rate controller 41B of the encoding portion 2B corresponding to the decoder state information 102 so as to suppress the occupancy rate of the buffer 21B from fluctuating and keep the process amount for the entire picture encoding format converting apparatus constant.

When encoder controlling information 103 is supplied from the decider 71 to the encoder controller 61B, the encoder controller 61B outputs rate controller controlling information 104 to the rate controller 41 of the encoding portion 2B.

(Ninth Embodiment)

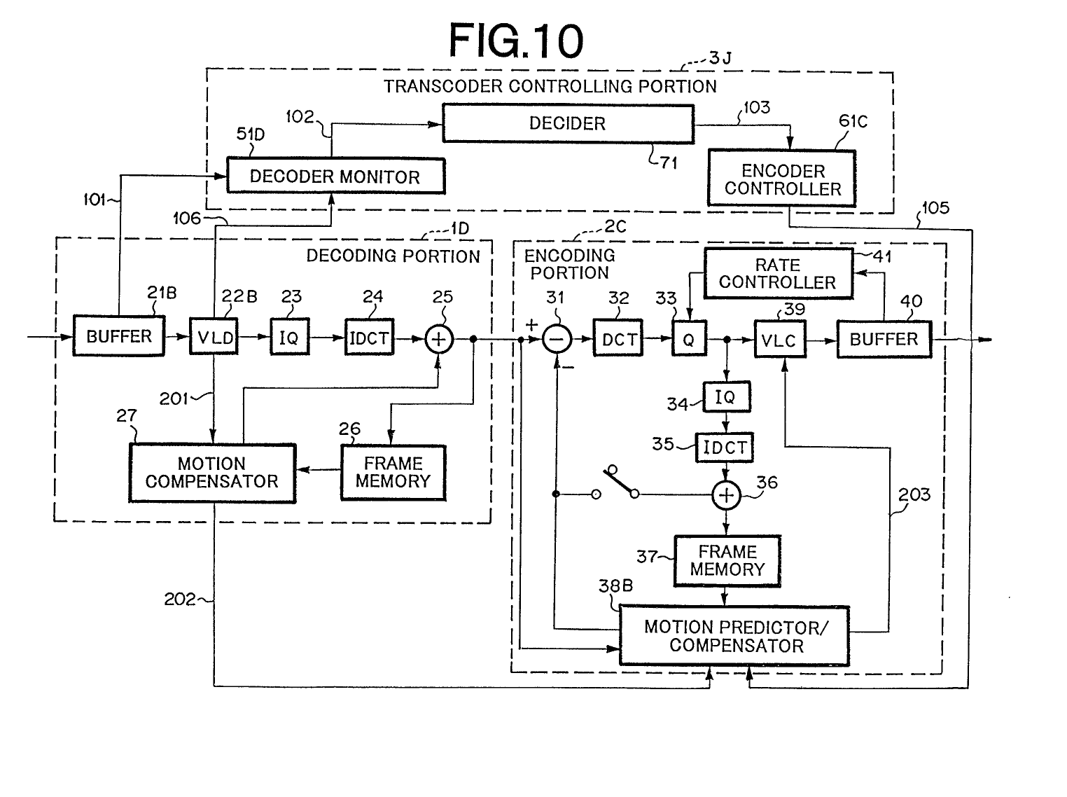

Next, with reference to FIG. 10, a ninth embodiment of the present invention will be explained.

Referring to FIG. 10, the ninth embodiment of the present invention comprises decoding portion 1D, encoding portion 2C, and transcoder controlling portion 3J. The decoding portion 1D comprises buffer 21B and VLD (Variable Length Decoder) 22B. The encoding portion 2C comprises motion predictor/compensator 38B. The transcoder controlling portion 3J comprises decoder monitor 51D, encoder controller 61C, and decider 71.

The decoding portion 1D further comprises IQ (Inversely Quantizer) 23, IDCT (Inversely Discrete cosine Transformer) 24, adder 25, frame memory 26, and motion compensator 27. The encoding portion 2C further comprises subtractor 31, DCT (Discrete Cosine Transformer) 32, Q (Quantizer) 33, IQ 34, IDCT 35, adder 36, frame memory 37, VLC (Variable Length Coder) 39, buffer 40, and rate controller 41.

Next, with reference to FIG. 10, the operation of the picture encoding format converting apparatus according to the ninth embodiment of the present invention will be explained.

First of all, the operation of the decoding portion 1D will be explained.

The operations of the buffer 21B, the IQ 23, the IDCT 24, the adder 25, the frame memory 26, and the motion compensator 27 according to the ninth embodiment are the same as those according to the second embodiment.

The operation of the VLD 22B according to the ninth embodiment is the same as that according to the fifth embodiment.

The operation of the encoding portion 2 according to the ninth embodiment is the same as that according to the third embodiment.

Next, the operation of the transcoder controlling portion 3J will be explained.

The decoder monitor 51D monitors the occupancy rate of the buffer 21B of the decoding portion 1D.

The decoder monitor 51D calculates how much process amount the decoding portion 1D requires to decode a predetermined unit picture on the basis of encoding parameters 106 which are supplied from the VLD portion 22B of the decoding portion 1D.

The decoder monitor 51D outputs decoder state information 102 to the decider 71 on the basis of both buffer occupancy rate information 101 and encoding parameters 106.

The decider 71 decides the operation of the motion predictor/compensator 38B of the encoding portion 2C on the basis of the decoder state information 102 so as to suppress the occupancy rate of the buffer 21B from fluctuating and keep the process amount for the entire picture encoding format converting apparatus constant.

When encoder controlling information 103 is supplied from the decider 71 to the encoder controller 61C, the encoder controller 61C outputs motion predictor/compensator controlling information 105 to the motion predictor/compensator 38B of the encoding portion 2C.

(Tenth Embodiment)

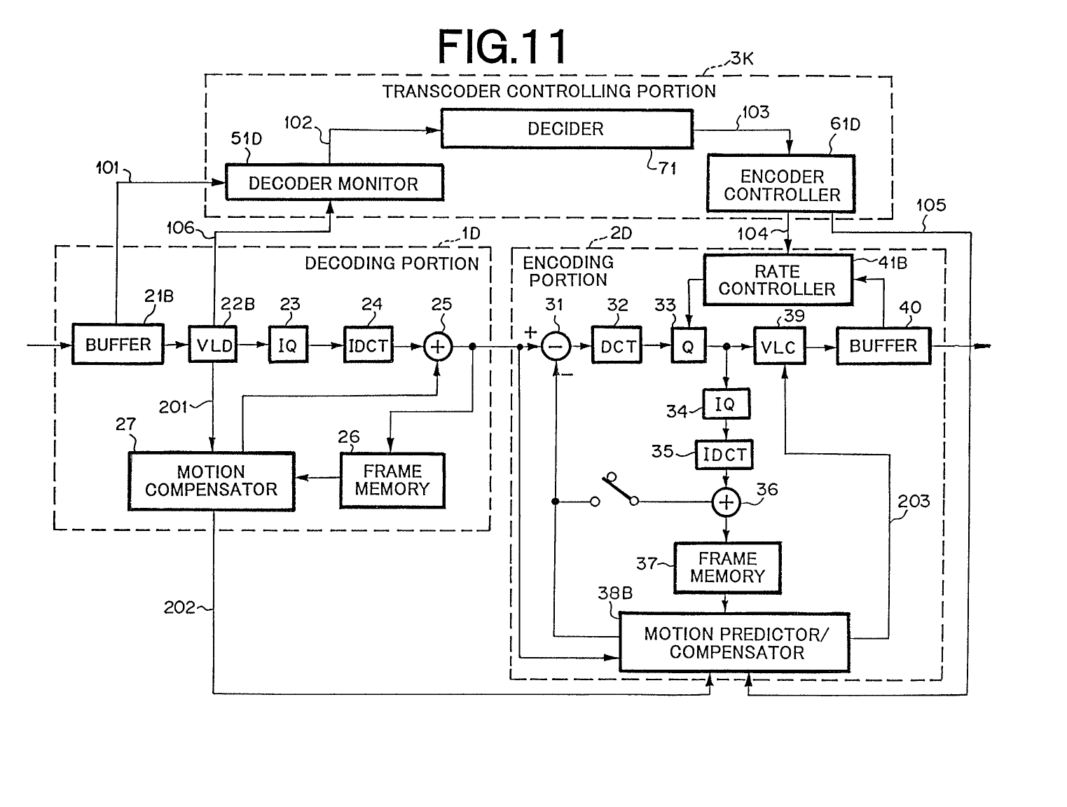

Next, with reference to FIG. 11, a tenth embodiment of the present invention will be explained.

Referring to FIG. 11, the tenth embodiment of the present invention comprises decoding portion 1D, encoding portion 2D, and transcoder controlling portion 3K. The decoding portion 1D comprises buffer 21B and a VLD (Variable Length Decoder) 22B. The encoding portion 2D comprises motion predictor/compensator 38B and rate controller 41B. The transcoder controlling portion 3K comprises decoder monitor 51D, encoder controller 61D, and decider 71.

The decoding portion 1D further comprises IQ (Inversely Quantizer) 23, an IDCT (Inversely Discrete Cosine Transformer) 24, adder 25, frame memory 26, and motion compensator 27. The encoding portion 2D further comprises subtactor 31, DCT (Discrete Cosine Transformer) 32, Q (Quantizer) 33, IQ 34, IDCT 35, adder 36, frame memory 37, VLC (Variable Length Coder) 39, and buffer 40.

Next, with reference to FIG. 11, the operation of the picture encoding format converting apparatus according to the tenth embodiment of the present invention will be explained.

First of all, the operation of the decoding portion 1D will be explained.

The operations of the buffer 21B, the IQ 23, the IDCT 24, the adder 25, the frame memory 26, and the motion compensator 27 according to the tenth embodiment are the same as those according to the second embodiment.

The operation of the VLD 22B according to the tenth embodiment is the same as that according to the fifth embodiment.

The operation of the encoding portion 2D according to the tenth embodiment is the same as that according to the fourth embodiment.

Next, the operation of the transcoder controlling portion 3K will be explained.

The decoder monitor 51D monitors the occupancy rate of the buffer 21B of the decoding portion 1D.

The decoder monitor 51D calculates how much process amount the decoding portion 1D requires to decode a predetermined unit picture on the basis of encoding parameters 106 which are supplied from the VLD portion 22B of the decoding portion 1D.

The decoder monitor 51D outputs decoder state information 102 to the decider 71 on the basis of both buffer occupancy rate information 101 and the encoding parameters 106.

The decider 71 decides the operations of the rate controller 41B and the motion predictor/compensator 38B of the encoding portion 2C on the basis of the decoder state information 102 so as to suppress the occupancy rate of the buffer 21B from fluctuating and keep the process amount for the entire picture encoding format converting apparatus constant.

Like the fourth embodiment, when encoder controlling information 103 is supplied from the decider 71 to the encoder controller 61D, the encoder controller 61D outputs rate controller controlling information 104 and/or motion predictor/compensator controlling information 105 to the rate controller 41B and/or the motion predictor/compensator 38B of the encoding portion 2D.

As was explained above, according to the present invention, since the occupancy rate of the input buffer of the picture encoding format converting apparatus is controlled, the delay which takes place in the input buffer can be decreased.

In addition, according to the present invention, since the entire process amount of the decoding portion and the encoding portion can be controlled, the calculation amount for encoding and decoding a predetermined number of macro blocks becomes constant. Thus, the picture encoding format converting apparatus can be controlled so that the process time thereof becomes constant.

Further, according to the present invention, the encoding method can be dynamically and flexibly changed corresponding to the network state and picture state.

Still further, according to the present invention, the process performance of the picture encoding format converting apparatus can be fully used.

Although the present invention has been shown and explained with respect to the best mode embodiment thereof, it should be understood by those skilled in the art that the foregoing and various other changes, omissions, and additions in the form and detail thereof may be made therein without departing from the spirit and scope of the present invention.

What is claimed is:

1. A picture encoding format converting apparatus, comprising:
a picture decoder for decoding a picture signal from an input bitstream;
a picture encoder for encoding said picture signal into an output bitstream;
a main controller for controlling the amount of calculations executed by said picture encoder, on the basis of a state of said picture decoder.

2. The picture encoding format converting apparatus as set forth in claim 1,
wherein said picture decoder comprises a buffer for temporarily storing said input bitstream,
said picture encoder comprises a rate controller for controlling a rate of said output bitstream, and
said main controller comprises:
a monitor for monitoring an occupancy rate of said buffer; and
a sub-controller for controlling the amount of calculations executed by said rate controller, on the basis of said occupancy rate in order to suppress fluctuation of said occupancy rate.

3. The picture encoding format converting apparatus as set forth in claim 1,
wherein said picture decoder comprises a buffer for temporarily storing said input bitstream,
said picture encoder comprises a motion predictor for predicting motions in a picture represented by said picture signal, and
said main controller comprises:
a monitor for monitoring an occupancy rate of said buffer; and
a sub-controller for controlling the amount of calculations executed by said motion predictor, on the basis of said occupancy rate in order to suppress fluctuation of said occupancy rate.

4. The picture encoding format converting apparatus as set forth in claim 1,
wherein said picture decoder comprises a buffer for temporarily storing said input bitstream,
said picture encoder comprises:
a rate controller for controlling a rate of said output bitstream; and
a motion predictor for predicting motions in a picture represented by said picture signal, and
said main controller comprises:
a monitor for monitoring an occupancy rate of said buffer; and
a sub-controller for controlling the amount of calculations executed by said rate controller and/or the amount of calculations executed by said motion predictor, on the basis of said occupancy rate in order to suppress fluctuation of said occupancy rate.

5. The picture encoding format converting apparatus as set forth in claim 1,
wherein said picture decoder comprises a variable length decoder for decoding data of said picture signal from codes in said input bitstream,
said picture encoder comprises a rate controller for controlling a rate of said output bitstream, and
said main controller comprises:
a monitor for monitoring encoding parameters decoded by said variable length decoder and for calculating the amount of calculations needed by said picture decoder; and
a sub-controller for controlling the amount of calculations executed by said rate controller, on the basis of the amount of calculations needed by said picture decoder in order to keep the sum of the amount of calculations executed by said picture decoder and the amount of calculations executed by said picture encoder constant.

6. The picture encoding format converting apparatus as set forth in claim 1,
wherein said picture decoder comprises a variable length decoder for decoding data of said picture signal from codes in said input bitstream,
said picture encoder comprises a motion predictor for predicting motions in a picture represented by said picture signal, and
said main controller comprises:
a monitor for monitoring encoding parameters decoded by said variable length decoder and for calculating the amount of calculations needed by said picture decoder; and
a sub-controller for controlling the amount of calculations executed by said motion predictor, on the basis of the amount of calculations needed by said picture decoder in order to keep the sum of the amount of calculations executed by said picture decoder and the amount of calculations executed by said picture encoder constant.

7. The picture encoding format converting apparatus as set forth in claim 1,
wherein said picture decoder comprises a variable length decoder for decoding data of said picture signal from codes in said input bitstream,
said picture encoder comprises:
a rate controller for controlling a rate of said output bitstream; and
a motion predictor for predicting motions in a picture represented by said picture signal, and
said main controller comprises:
a monitor for monitoring encoding parameters decoded by said variable length decoder and for calculating the amount of calculations needed by said picture decoder; and
a sub-controller for controlling the amount of calculations executed by said rate controller and/or the amount of calculations executed by said motion predictor, on the basis of the amount of calculations needed by said picture decoder in order to keep the sum of the amount of calculations executed by said picture decoder and the amount of calculations executed by said picture encoder constant.

8. The picture encoding format converting apparatus as set forth in claim 1,
wherein said picture decoder comprises:
a buffer for temporarily storing said input bitstream; and
a variable length decoder for decoding data of said picture signal from codes in said input bitstream,
said picture encoder comprises a rate controller for controlling a rate of said output bitstream, and
said main controller comprises:
a monitor for monitoring an occupancy rate of said buffer, for monitoring encoding parameters decoded by said variable length decoder, and for calculating the amount of calculations needed by said picture decoder; and
a sub-controller for controlling the amount of calculations executed by said rate controller, on the basis of said occupancy rate and/or the amount of calculations needed by said picture decoder in order to suppress fluctuation of said occupancy rate and/or keep the sum of the amount of calculations executed by said picture decoder and the amount of calculations executed by said picture encoder constant.

9. The picture encoding format converting apparatus as set forth in claim 1,
wherein said picture decoder comprises:
a buffer for temporarily storing said input bitstream; and
a variable length decoder for decoding data of said picture signal from codes in said input bitstream,
said picture encoder comprises a motion predictor for predicting motions in a picture represented by said picture signal, and
said main controller comprises:
a monitor for monitoring an occupancy rate of said buffer, for monitoring encoding parameters decoded by said variable length decoder, and for calculating the amount of calculations needed by said picture decoder; and
a sub-controller for controlling the amount of calculations executed by said motion predictor, on the basis of said occupancy rate and/or the amount of calculations needed by said picture decoder in order to suppress fluctuations of said occupancy rate and/or keep the sum of the amount of calculations executed by said picture decoder and the amount of calculations executed by said picture encoder constant.

10. The picture encoding format converting apparatus as set forth in claim 1,
wherein said picture decoder comprises:
a buffer for temporarily storing said input bitstream; and
a variable length decoder for decoding data of said picture signal from codes in said input bitstream,
said picture encoder comprises:
a rate controller for controlling a rate of said output bitstream; and
a motion predictor for predicting motions in a picture represented by said picture signal, and
said main controller comprises:
a monitor for monitoring an occupancy rate of said buffer, for monitoring encoding parameters decoded by said variable length decoder, and for calculating the amount of calculations needed by said picture decoder; and
a sub-controller for controlling the amount of calculations executed by said rate controller and/or the amount of calculations executed by said motion predictor, on the basis of said occupancy rate and/or the amount of calculations needed by said picture decoder in order to suppress fluctuations of said occupancy rate and/or the sum of the amount of calculations executed by said picture decoder and the amount of calculations executed by said picture encoder constant.

11. An encoding format converting apparatus, comprising:
a buffer for inputting encoded data and temporarily storing said encoded data;
a decoder for decoding said data which has been temporarily stored in said buffer;
an encoder for re-encoding said data which has been decoded by said decoder; and
a controller for controlling the amount of calculations executed by said encoder in order to keep an occupancy rate of said buffer.

12. An encoding format converting apparatus, comprising:
a decoder for decoding data;
an encoder for re-encoding said data which has been decoded by said decoder; and
a controller for controlling the amount of calculations executed by said encoder in order to keep the sum of the amount of calculations executed by said decoder and the amount of calculations executed by said encoder constant, on the basis of the amount of calculations needed by said encoder.
